(19) United States
(12) Patent Application Publication
(10) Pub. No.: US 2017/0273499 A1
(43) Pub. Date: Sep. 28, 2017

(54) COFFEE PERCOLATOR

(71) Applicant: YUKAWA ENTERPRISE CO., LTD, Hemei Township (TW)

(72) Inventor: Chin-Chen YEH, Changhua City (TW)

(73) Assignee: YUKAWA ENTERPRISE CO., LTD, Hemei Township (TW)

(21) Appl. No.: 15/079,509

(22) Filed: Mar. 24, 2016

(51) Int. Cl. A47J 31/44; A47J 31/20; A47J 31/06

(52) U.S. Cl. CPC A47J 31/446; A47J 31/06; A47J 31/20

(57) ABSTRACT

A coffee percolator is provided having a funnel-shaped main body made of a thin stainless steel sheet and an inner layer component, wherein the sidewall of the main body is formed with a plurality of holes by means of etching technology; the inner layer component is fixed on the inner side of the sidewall of the main body. The inner layer component is provided with second holes with smaller diameter than that of the first holes provided on the sidewall of the main body. Through the double-layer wall structure made up of the inner layer component and main body side wall for the liquid to pass through and the fine second holes provided on the inner layer component, coffee grounds and foreign bodies can be completely prevented from passing through the sidewall when preparing and filtering coffee, so that the coffee prepared by the user has better purity and taste.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT Not applicable.

### REFERENCE TO AN APPENDIX SUBMITTED ON COMPACT DISC Not applicable.

### BACKGROUND OF THE INVENTION

1. Field of the Invention

The present invention relates generally to the structure of an apparatus for preparing coffee, and more particularly to a coffee percolator which can ride on a cup so that the user can pour hot water to percolate coffee.

2. Description of Related Art Including Information Disclosed Under 37 CFR 1.97 and 37 CFR 1.98.

At present, there are three kinds of home-made coffee: instant coffee, percolated coffee, and brewed coffee. Instant coffee is prepared by pouring a kind of powder containing coffee, cream, and sugar (as what is called 3-in-1 coffee) into a cup and adding hot water. This kind of coffee cannot provide the rich fragrance of coffee. Brewed coffee is boiled by a coffee machine. Prices of coffee machines may vary greatly depending on the functions and professional brewing levels, and the taste of brewed coffee may also be different. Hence, popular coffee machines are those common models; however, some people still do not like using common coffee machines because of the complicated processes in preparing coffee and the difficulty in cleaning the machine after use.

Percolated coffee is an alternative apart from coffee machine and instant coffee. Typically, a coffee apparatus formed with a cone-shaped inner space is used to percolate coffee. Holes are provided on the bottom end and sidewall of the coffee apparatus main body; to use, the user ride the coffee apparatus main body on the rim of a cup, put a piece of filter paper in the inner space of the coffee apparatus main body, and pour ground coffee on the filter paper, then pour boiled water on the filter paper placed inside the coffee apparatus main body, so the hot water slowly penetrates into the coffee powder, passes through the filter paper, flows out of the bottom of the main body, and drips into the cup. In this way, the ingredients of coffee will be extracted, and the user can enjoy rich, tasty, and fragrant percolated coffee.

Another type of percolated coffee apparatus main body is made of a thin sheet of stainless steel material with a plurality of fine holes formed by means of etching technology, and the stainless steel sheet is formed into a cone-shaped funnel; to use, the user can directly put coffee powder into the coffee apparatus main body, and then pour hot water into the apparatus. The hot water will gradually penetrate into the coffee powder and flow out of the holes of the main body, and the extracted coffee solution will drip into the cup.

To some degree, the above-mentioned coffee apparatus main body with a plurality of fine holes formed by means of etching technology can provide the function to filter coffee grounds and foreign objects. However, due to the practical limitations of etching technology, the holes formed cannot be further finer. Hence, the coffee apparatus still cannot filter finer coffee grounds and foreign objects.

Thus, to overcome the aforementioned problems of the prior art, it would be an advancement in the art to provide an improved structure that can significantly improve the efficacy. Therefore, the inventor has provided the present invention of practicability after deliberate design and evaluation based on years of experience in the production, development and design of related products.

### BRIEF SUMMARY OF THE INVENTION

The “coffee percolator” disclosed in the present invention is characterized by an innovative structure of a main body having first holes and an inner layer component having second holes, and a unique technical feature that the diameter of the second holes is smaller than that of the first holes. Based on the above characteristics, the present invention offers better function than the existing structure of “prior art”. Through the double-layer wall structure made up of the inner layer component and main body sidewall for liquid to pass through, and the fine second holes provided on the inner layer component, coffee grounds and foreign objects can be completely prevented from passing through the main body sidewall when percolating coffee, and the user can enjoy percolated coffee with better purity and taste. This is indeed a practical advancement.

### BRIEF DESCRIPTION OF THE SEVERAL VIEWS OF THE DRAWINGS

FIG. 1 is a perspective view of a preferred embodiment of the coffee percolator structure of the present invention.

FIG. 2 is a lateral view of a preferred embodiment of the coffee percolator structure of the present invention.

FIG. 3 is an enlarged view of Part B in FIG. 2.

FIG. 4 is a partial sectional and enlarged view of a preferred embodiment of the coffee percolator structure of the present invention.

FIG. 5 is an operational view of the coffee percolator of the present invention.

FIG. 6 is a perspective view of another embodiment of the coffee percolator structure of the present invention.

FIG. 7 is an operational view of the embodiment disclosed in FIG. 6.

### DETAILED DESCRIPTION OF THE INVENTION

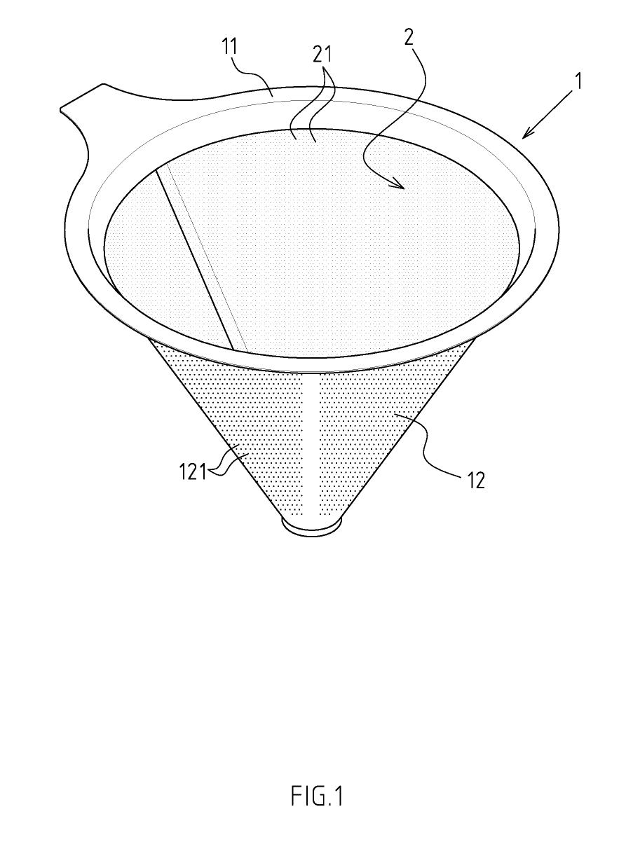

A preferred embodiment of the coffee percolator of the present invention is disclosed in FIGS. 1 to 4. However, such an embodiment is for the purpose of description only and is not intending to limit the scope of patent claims.

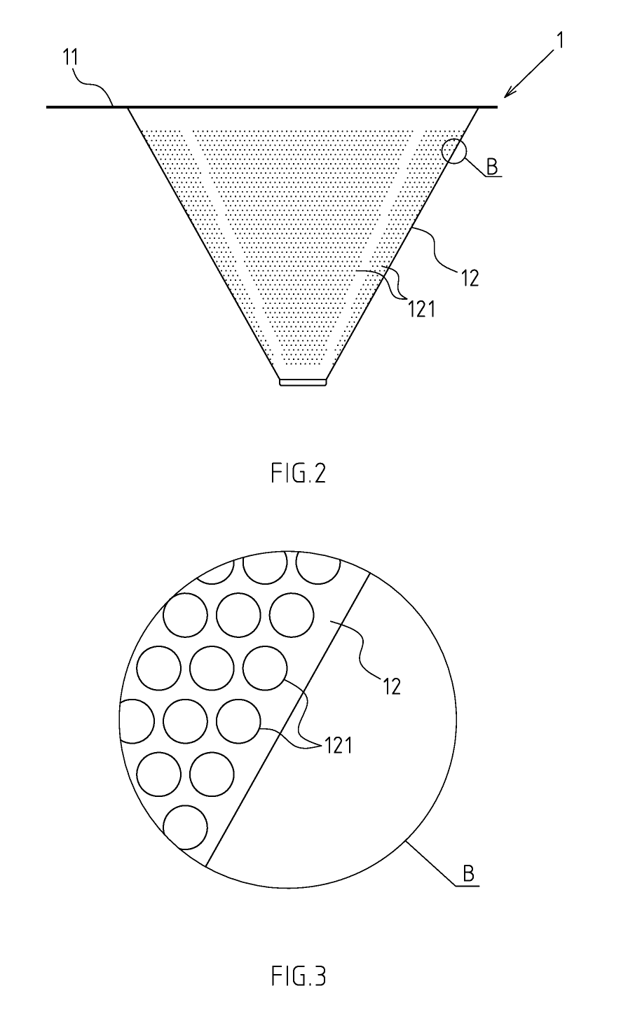

Referring to FIGS. 1 and 2, the main structure of the coffee percolator provided by the present invention comprises a main body 1 and an inner layer component 2; wherein, said main body 1 has a ring frame 11, and the inner rim of said ring frame 11 is bonded with a sidewall 12 formed into a conic shape. Said ring frame 11 can be made of stainless steel material. The preferred embodiment of the sidewall 12 is made of a thin stainless steel sheet formed into the shape of a funnel having an inner space. Before forming into the conic shape, the sidewall 12 is configured with a plurality of through first holes 121 (see FIG. 3 for details) made by means of chemical etching technology. The first holes 121 are intensively distributed on the sidewall 12 to the degree that they are hardly seen clearly by the naked human eye. However, the first holes 121 can still let liquid pass through; in another word, liquid can percolate through the first holes 121.

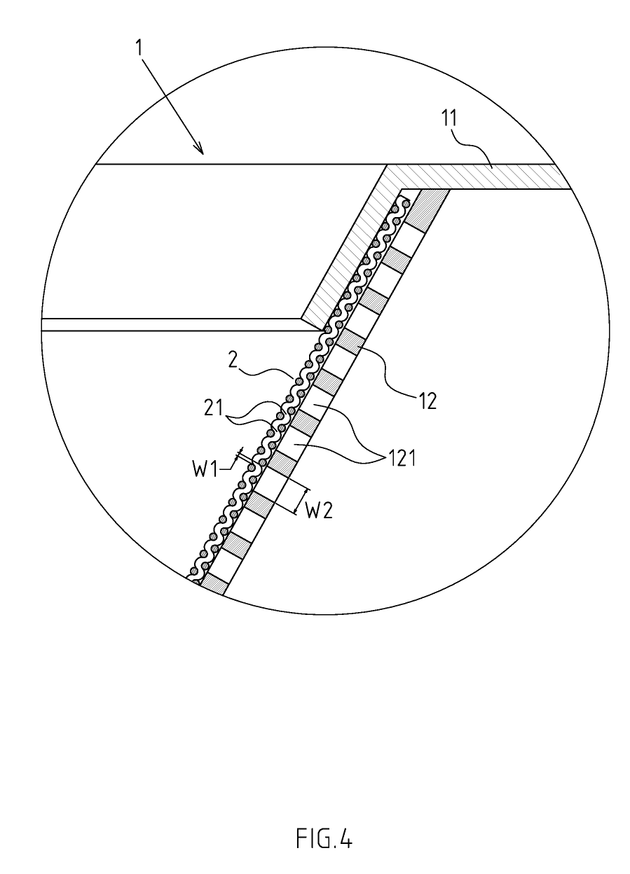

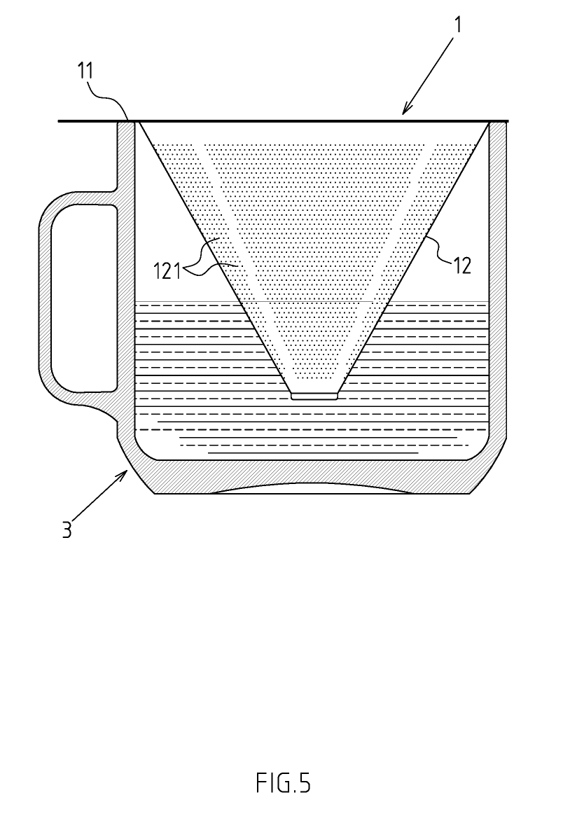

The preferred embodiment of the inner layer component 2 of the present invention is formed into the shape of a funnel to correspond the contour and shape of the inner side of the sidewall 12 of the main body 1, and the inner layer component 2 is fixed on the inner side of the sidewall 12; said inner layer component 2 is configured with a plurality of second holes 21 as shown in FIG. 4, and the diameter of the second holes 21 (W1) is smaller than the diameter of the first holes 121 of said main body 1 (W2). The inner layer component 2 and the sidewall 12 of the main body 1 constitute a double-layer wall structure for liquid to pass through. In order for the diameter of the second holes 21 to be smaller than the diameter of the first holes 121, a preferred embodiment of the present invention adopts fine wires of stainless steel material, which are formed into an inner layer component 2 with a plurality of second holes 21, i.e., the plurality of second holes 21 form a mesh structure with very fine meshes.

Preferably, said inner layer component 2 of the present invention can be in the form of a mesh structure woven from fine stainless steel wires, and the fine meshes between the stainless steel wires form the second holes 21 (as shown in FIG. 4); i.e., knitting technology is used to weave stainless steel wires into a metal net with very fine meshes, so that the inner layer component 2 has sufficient flexibility and elasticity, can let liquid pass through, and can provide finer filtering function than the sidewall 12 of the main body 1, and can consequently replace filter paper to accomplish a good effect for coffee percolation; on the other hand, the main body 1 on the outer side of the inner layer component 2 can provide a shell structure with relatively better rigidity to effectively avoid deformation and damage of the inner layer component 2.

Based on said structure of the coffee percolator disclosed by the present invention, its operation is as illustrated in FIG. 5. The main body 1 can be directly placed above a cup 3, with the ring frame 11 supported by the rim of the cup, the user can directly put ground coffee powder into the main body 1, then slowly pour hot water into the main body 1. The hot water will gradually penetrate into the coffee powder to extract coffee ingredients, and then pass through the second holes 21 (see FIG. 4) and first holes 121, and finally drip into the cup 3. As the second holes 21 of the inner layer component 2 are very fine, coffee grounds or foreign objects of any size can be effectively blocked and separated, and the coffee inside the cup can have better purity and taste.

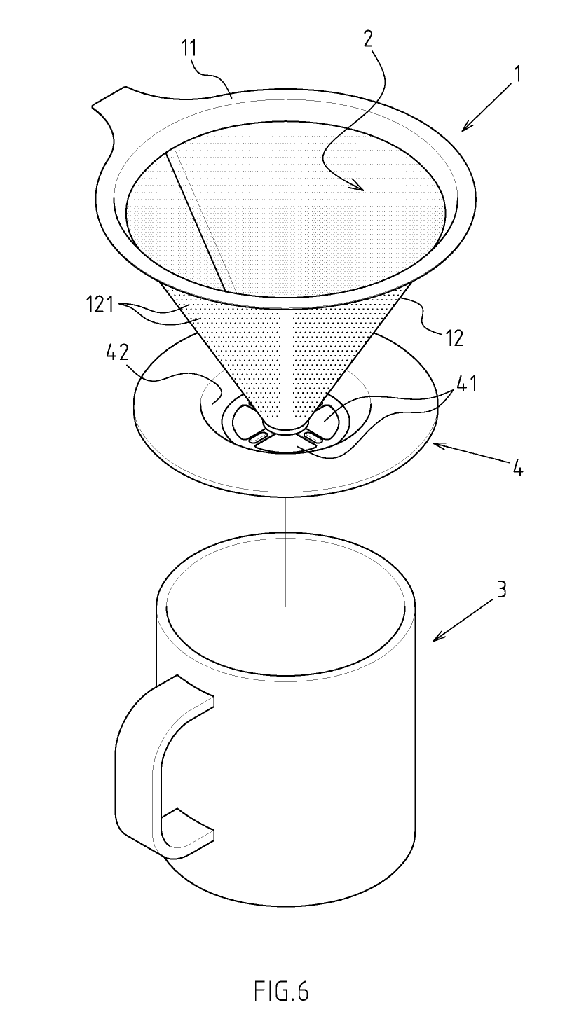

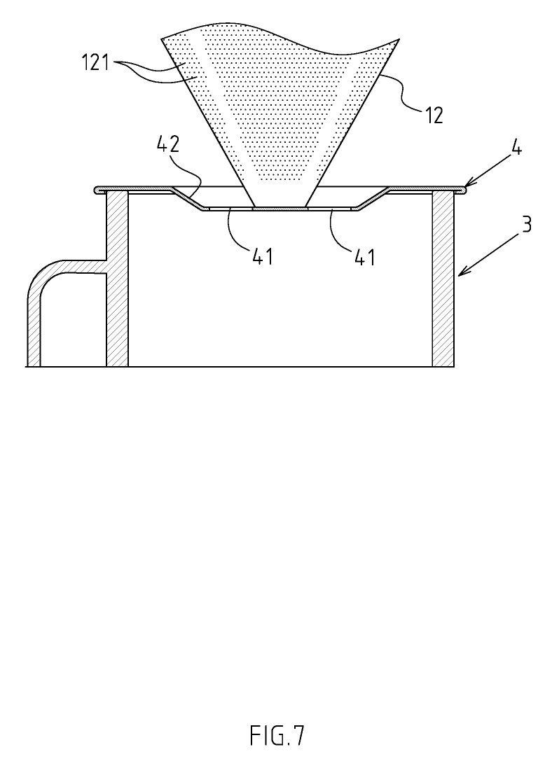

Further referring to FIG. 6, the bottom end of the tunnel shape of the main body 1 can be further connected and fixed with a plate body 4. Said plate body 4 is configured with dripping holes 41 for liquid to pass through; the configuration of a plate body 4 in this embodiment is to enable the present invention to ride over an existing cup 3 (as shown in FIG. 7). In this way, the main body 1 is elevated to a level above the cup rim, and the inner holding space of the cup 3 will not be affected; moreover, in this embodiment, the peripheral of the dripping holes 41 can be further connected to the plate body 4 through a conic ring surface 42; said conic ring surface 42 offers a function to collect and guide the coffee dripping down from the percolator.

I claim:

1. A coffee percolator, comprising:
a main body, having a sidewall made of stainless steel sheet formed into the shape of a funnel having an inner space, said sidewall being configured with a plurality ofperforated first holes formed by means of etching technology;
an inner layer component, formed in the shape of a funnel corresponding to the contour and shape of the inner side of the sidewall of the main body, and said inner layer component is fixed on the inner side of the sidewall, said inner layer component is provided with a plurality of second holes, and the diameter of said second holes is smaller than that of the first holes, said inner layer component and said main body sidewall constitute a double-layer wall structure for liquid to pass through.

2. The structure defined in claim 1, wherein said inner layer component is in the form of a wire mesh woven from stainless steel wires, and said second holes are formed by the fine meshes between the stainless steel wires.

3. The structure defined in claim 2, wherein the bottom end of the funnel shape of said main body is connected and fixed with a plate body, said plate body is provided with a dripping hole for liquid to pass through.

4. The structure defined in claim 3, wherein the peripheral of the dripping holes is further connected to the plate body through a conic ring surface.
